(19) United States
(12) Patent Application Publication
(10) Pub. No.: US 2026/0237859 A1
(43) Pub. Date: Aug. 13, 2026

(54) ENERGY STORAGE ALL-IN-ONE MACHINE AND ENERGY STORAGE SYSTEM

(71) Applicant: Sungrow Power Supply Co., Ltd., Hefei, Anhui (CN)

(72) Inventors: Wengong Dong, Hefei (CN); Qiangdong Chen, Hefei (CN); Fei Chen, Hefei (CN); Lin Wang, Hefei (CN); Xuteng Li, Hefei (CN); Yuchao Yuan, Hefei (CN); Leiyi Lv, Hefei (CN); Ying Cao, Hefei (CN); Jing Xiao, Hefei (CN); Yongwei Jin, Hefei (CN)

(73) Assignee: Sungrow Power Supply Co., Ltd., Hefei, Anhui (CN)

(21) Appl. No.: 19/160,805

(22) PCT Filed: Aug. 21, 2023
(86) PCT No.: PCT/CN2023/113946

§ 371 Date: Aug. 28, 2025

(30) Foreign Application Priority Data
Jun. 27, 2023 (CN) 202321666664.2

(51) Int. Cl. H01M 50/503; H01M 10/42; H01M 50/204; H01M 50/24

(52) U.S. Cl. CPC H01M 50/503; H01M 10/425; H01M 50/204; H01M 50/24

(57) ABSTRACT

An energy storage all-in-one machine and an energy storage system are provided. The energy storage all-in-one machine includes a battery, a switch box, and at least two connectors. The switch box is electrically connected to the battery; and the connectors are used for achieving capacity expansion of the energy storage all-in-one machine.

This application is a national stage filing under 35 U.S.C. § 371 of International Patent Application Serial No. PCT/CN 2023/113946, filed Aug. 21, 2023, which claims the priority to Chinese Patent Application No. 202321666664.2, titled “ENERGY STORAGE ALL-IN-ONE MACHINE AND ENERGY STORAGE SYSTEM”, filed with the China National Intellectual Property Administration on Jun. 27, 2023. The contents of these applications are incorporated herein by reference in their entirety.

### FIELD

The present application relates to the technical field of battery energy storage, and in particular, to an all-in-one energy storage device and an energy storage system.

### BACKGROUND

An all-in-one energy storage device is a device that stores energy and releases energy when needed, which can reasonably utilize energy and increase energy utilization, and is widely applied in daily life. A single all-in-one energy storage device has limited energy storage capacity and may not meet energy storage needs of all users. Therefore, users typically need to configure additional batteries or all-in-one energy storage devices to meet various requirements for capacity expansion. The conventional all-in-one energy storage devices are complicated in wiring, which results in complicated and cumbersome operation for capacity expansion and inconvenient maintenance.

### SUMMARY

The present application aims to address at least one of technical issues in the related art. To this end, the present application proposes an all-in-one energy storage device and an energy storage system. By providing connectors in the all-in-one energy storage device, wiring connections between the all-in-one energy storage device and external devices can be reduced, capacity expansion is convenient, and the installation of the all-in-one energy storage device is simplified. Even when the all-in-one energy storage device needs to be replaced or debugged, a single all-in-one energy storage device can be quickly disassembled by directly unplugging a cable connected to a corresponding connector of the all-in-one energy storage device, which is simple to operate and saves time and labor.

In a first aspect, an all-in-one energy storage device is provided according to the present application, which includes:
a battery;
a switch box which is electrically connected to the battery;
at least two connectors which are configured for expanding capacity of the all-in-one energy storage device.

In a second aspect, an energy storage system is provided according to the present application, which includes:
a power conversion system; and
at least two all-in-one energy storage devices as described above, where a connector of one of the all-in-one energy storage devices is connected to a connector of another one of the all-in-one energy storage devices such that the all-in-one energy storage devices are connected in sequence, and the power conversion system is connected to a connector of one of the all-in-one energy storage devices.

### BRIEF DESCRIPTION OF THE DRAWINGS

The above and/or additional aspects and advantages of the present application will become apparent and readily understood from the description of embodiments taken in conjunction with the following drawings.

FIG. 1 is a schematic structural diagram of an all-in-one energy storage device according to a first embodiment of the present application;

FIG. 2 is a schematic structural diagram of an all-in-one energy storage device according to a second embodiment of the present application;

FIG. 3 is a schematic structural diagram of an all-in-one energy storage device according to a third embodiment of the present application;

FIG. 4 is a schematic structural diagram of an energy storage system according to a first embodiment of the present application;

FIG. 5 is a schematic structural diagram of an energy storage system according to a second embodiment of the present application;

FIG. 6 is a schematic structural diagram of an energy storage system according to a third embodiment of the present application;

FIG. 7 is a schematic structural diagram of an energy storage system according to a fourth embodiment of the present application;

FIG. 8 is a schematic structural diagram of an energy storage system according to a fifth embodiment of the present application; and

FIG. 9 is a structural schematic diagram of an energy storage system according to a sixth embodiment of the present application.

Reference numerals in the figures are listed as follows:
100. all-in-one energy storage device;
110. battery holder;
111. accommodating groove;
112. first assembling and disassembling port;
113. second assembling and disassembling port;
130. switch box;
131. plug;
150. battery;
170. connector;
200. power conversion system;
300. cable.

### DETAILED DESCRIPTION OF THE EMBODIMENTS

Embodiments of the present application are described in detail below. Examples of the embodiments are shown in the drawings. Throughout the drawings, the same or similar reference numerals denote the same or similar elements or elements having the same or similar functions. The embodiments described below with reference to the drawings are exemplary and are only intended for illustrating the present application, and should not be construed as limitations of the present application.

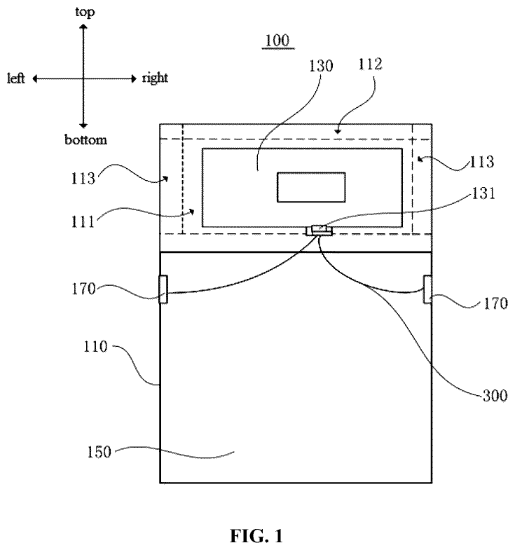

In the present application, a left-right direction refers to a length direction of a switch box 130 shown in FIG. 1, a front-rear direction refers to a width direction of the switch box 130, and an up-down direction refers to a height direction of the switch box 130, unless otherwise specified.

An all-in-one energy storage device 100 according to the embodiments of the present application is described below with reference to FIGS. 1 to 9. The all-in-one energy storage device 100 includes a battery 150, a switch box 130 and a connector 170.

The battery 150 is configured for storing and providing electric energy needed by users. It can be understood that, the specification and capacity of the battery 150 may be designed depending on actual conditions, and are not specifically limited in the embodiment.

The switch box 130 is electrically connected to the battery 150. That is, the battery 150 provides the switch box 130 with electric energy required for operation, and the switch box 130 is configured for monitoring a voltage, current, temperature and other parameter information of the battery 150 and managing and controlling a state of the battery 150.

In the embodiment, in view of the large size and heavy weight of the battery 150, the switch box 130 is located above the battery 150.

The connector 170 is configured for expanding capacity of the all-in-one energy storage device 100. At least two connectors 170 are respectively disposed on two sides of the battery 150 and electrically connected to the switch box 130.

It can be understood that, there are many electronic elements in the switch box 130, and the connectors 170 are connected to the switch box 130 by wires, so that when the switch box 130 needs to be replaced or debugged, it is only necessary to unplug the wires connecting the switch box 130 and the connectors 170, which significantly reduces the complexity of assembly and disassembly of the switch box 130.

In the embodiment, one of the connectors 170 located on the left and right sides of the battery 150 is a communication connector, and the other is a power connector. The communication connector is configured for realizing data transmission between the battery 150 and the switch box 130, and the power connector is configured for realizing current circulation. In other embodiments, the connectors 170 may include other connectors, which is not specifically limited in the embodiment.

In the related art, conventional connectors typically only support single-pole wire connection, such that each connector needs to be connected to a connector of another all-in-one energy storage device 100 through positive and negative wires when connecting multiple all-in-one energy storage devices 100, which not only increases usage and production costs of connectors, but also adversely affects rapid wiring between the multiple all-in-one energy storage devices 100, resulting in low work efficiency, a high risk of wiring errors and difficulties in maintenance.

Based on the above technical issues, in the embodiment, a connector 170 of one all-in-one energy storage device 100 can be electrically connected to a connector 170 of another all-in-one energy storage device 100 through a cable 300, such that the multiple all-in-one energy storage devices 100 are connected in sequence.

It can be understood that the connector 170 can be connected to the connector 170 of another all-in-one energy storage device 100 only by one cable 300, which improves modularity of the all-in-one energy storage device 100, significantly improves on-site wiring efficiency, reduces the risk of wiring errors, improves working efficiency, and reduces maintenance costs. It should be noted that the structure of the connector 170 is not specifically limited in the embodiment, as long as the connectors 170 can be electrically connected through one cable 300.

In the all-in-one energy storage device 100 according to the present application, by providing the connectors 170, wiring connections between the all-in-one energy storage device 100 and external devices can be reduced, capacity expansion is convenient, and the installation of the all-in-one energy storage device 100 is simplified. Even when the all-in-one energy storage device 100 needs to be replaced or debugged, the single all-in-one energy storage device 100 can be quickly disassembled by directly unplugging the cable 300 connected to the corresponding connector 170, which is simple to operate and saves time and labor.

In the related art, since a variety of electronic devices are provided in the switch box 130, the switch box 130 is typically connected to the battery 150 by a variety of wiring terminals, which also results in complicated assembly and disassembly of the switch box 130 and inconvenient maintenance.

In order to address the above issues, in some embodiments, the switch box 130 is electrically connected to the battery 150 by an aviation connector, which further simplifies the assembly and disassembly of the switch box 130 while realizing electrical connection between the switch box 130 and the battery 150.

It can be understood that one of the switch box 130 and the battery 150 is provided with a plug 131, and the other of the switch box 130 and the battery 150 is provided with a socket. The plug 131 is plugged in the socket to form the aviation connector.

Due to the plug-in connection of the switch box 130 and the battery 150, when the switch box 130 needs to be disassembled or replaced, the plug 131 can be directly unplugged from the socket after the wires connected to the connectors 170 are unplugged, which is simple to operate and saves time and labor. Further, due to the fact that the switch box 130 is connected to the battery 150 by the aviation connector formed by the plug 131 and the socket, the modularization of the switch box 130 and the battery 150 is further improved.

In some embodiments, the aviation connector for connecting the switch box 130 and the battery 150 is located at a lower end or a side end of the switch box 130. In the embodiment, the aviation connector for connecting the switch box 130 and the battery 150 is located on a lower side, a left side or a right side of the switch box 130. That is, an assembling and disassembling direction of the switch box 130 and the battery 150 includes a left-right direction and an up-down direction. By adjusting a position of the aviation connector for connecting the switch box 130 and the battery 150, the flexibility of the arrangement of the switch box 130 is improved.

Various users may require different spatial arrangements for the all-in-one energy storage device 100, and the assembling and disassembling direction of the switch box 130 in the related art is typically fixed and uniform. Thus, it is inconvenient to disassemble and replace a single switch box 130, which results in difficulties in maintenance.

In order to address the above issues, in some embodiments, the all-in-one energy storage device 100 further includes a battery holder 110 which defines an accommodating groove 111 and is provided with multiple assembling and disassembling ports.

The accommodating groove 111 is configured for receiving the battery 150 and the switch box 130.

In the embodiment, the switch box 130 is located above the battery 150. During assembly, the battery 150 needs to be placed into the accommodating groove 111 first to limit the battery 150 in the left-right direction and a front-rear direction, and then the switch box 130 is placed into the accommodating groove 111 and connected to the battery 150.

The assembling and disassembling ports are communicated with the accommodating groove 111. When the switch box 130 is placed in the accommodating groove 111 and is connected to the battery 150, there is a disassembling clearance between an inner wall of the accommodating groove 111 and an outer wall of the switch box 130, such that the switch box 130 can be taken out and placed through each of the multiple assembling and disassembling ports. It can be understood that the switch box 130 and the battery 150 can be easily separated from each other in the accommodating groove 111 due to the disassembling clearance between the inner wall of the accommodating groove 111 and the outer wall of the switch box 130, and the switch box 130 can be taken out or placed through different assembling and disassembling ports depending on actual conditions due to the multiple assembling and disassembling ports. As a result, the flexibility of the removal and placement of the switch box 130 is improved, the difficulties in maintenance are reduced, and the assembling and disassembling efficiency of the switch box 130 is improved.

In the embodiment of the present application, the battery holder 110 is provided with the multiple assembling and disassembling ports, and the disassembling clearance is formed between the inner wall of the accommodating groove 111 and the outer wall of the switch box 130, so that it is convenient to disassemble and replace a single switch box 130 when the multiple all-in-one energy storage devices 100 are arranged in combination, which improves the convenience of maintenance.

In the embodiment, opening directions of at least two of the assembling and disassembling ports are perpendicular to each other. Accordingly, regardless of whether multiple battery holders 110 are arranged in the front-rear direction or the left-right direction, when a switch box 130 on a certain battery holder 110 needs to be maintained or replaced, the switch box 130 can be taken out or placed through different assembling and disassembling ports depending on actual conditions, without moving away an all-in-one energy storage device 100 adjacent to the switch box 130 and the power conversion system 200 located above the all-in-one energy storage device 100. As a result, the flexibility of the removal and placement of the switch box 130 is improved, the difficulties in maintenance are reduced, and the assembling and disassembling efficiency of the switch box 130 is improved.

In the embodiment, a plug-in direction of the aviation connector for connecting the battery 150 and the switch box 130 is consistent with the opening direction of one of the assembling and disassembling ports, such that when assembling a single all-in-one energy storage device 100, the switch box 130 can be directly pushed into the accommodating groove 111 through the assembling and disassembling port having the opening direction consistent with the plug-in direction until the switch box 130 is connected to the battery 150, which improves the installation efficiency. In the embodiment, the assembling and disassembling ports includes a first assembling and disassembling port 112 and a second assembling and disassembling port 113. The first assembling and disassembling port 112 opens upward, and a first disassembling clearance is defined between an upper end face of the switch box 130 and a top face of the accommodating groove 111. The second assembling and disassembling port 113 opens to the left or right, and a second disassembling clearance is formed between an end face of the switch box 130 close to the second assembling and disassembling port and a corresponding side wall of the accommodating groove 111, and the first disassembling clearance and the second disassembling clearance form the disassembling clearance.

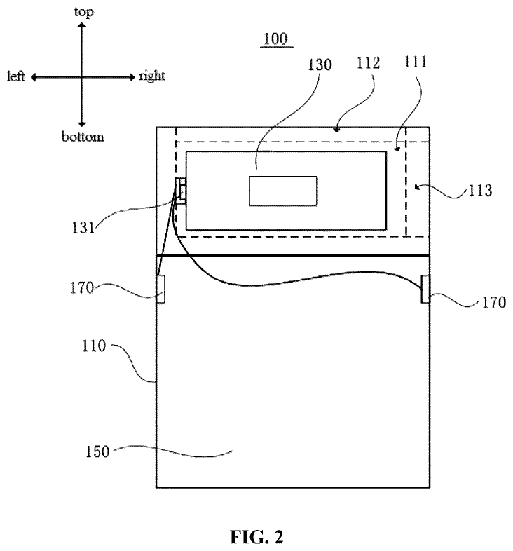

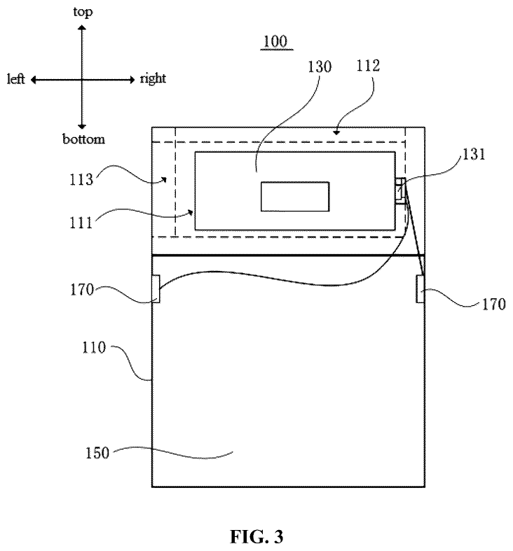

As shown in FIG. 2, the second assembling and disassembling port 113 opens to the right, and the second disassembling clearance is formed between a left end face of the switch box 130 and a left side wall of the accommodating groove 111. As shown in FIG. 3, the second assembling and disassembling port 113 opens to the left, and the second disassembling clearance is formed between a right end face of the switch box 130 and a right side wall of the accommodating groove 111.

By providing the first assembling and disassembling port 112 and the second assembling and disassembling port 113, it is ensured that the switch box 130 can be conveniently disassembled or replaced whether the multiple battery holders 110 are arranged in the left-right direction or the front-rear direction, or the power conversion system 200 is placed above the all-in-one energy storage device 100. It should be noted that the sizes of the first disassembling clearance and the second disassembling clearance may be designed depending on the size of a connection part between the switch box 130 and the battery 150, which is not specifically limited in the embodiment.

In some embodiments, as shown in FIG. 1, the number of the second assembling and disassembling ports 113 is two, and the two second assembling and disassembling ports 113 are oppositely arranged in the left-right direction. That is, one of the second assembling and disassembling ports 113 opens to the left, and a second disassembling clearance is formed between the right end face of the switch box 130 and the right side wall of the accommodating groove 111, while the other of the assembling and disassembling ports 113 opens to the right, and a second disassembling clearance is formed between the left end face of the switch box 130 and the left side wall of the accommodating groove 111. It can be understood that the sizes of the two second disassembling clearances may be equal or unequal, which is not specifically limited in the embodiment.

It can be understood that each of a front end face and a rear end face of the switch box 130 abuts against an inner wall of the accommodating groove 111 to avoid excessive concentration of stress on the connection part of the switch box 130 and the battery 150, especially when a surface where the battery holder 110 is placed is uneven, the connection part of the battery holder 110 and the battery 150 is not located on a center line of the switch box 130, or the connection part of the switch box 130 and the battery 150 is located on the left end face or the right end face of the switch box 130 as shown in FIGS. 2 and 3.

In some embodiments, when the connection part of the switch box 130 and the battery 150 is located at a lower end face of the switch box 130, the assembling and disassembling ports further include two third assembling and disassembling ports which are oppositely arranged in the front-rear direction, and a third disassembling clearance is formed between an end face of the switch box 130 close to each of the third assembling and disassembling ports and a corresponding side wall of the accommodating groove 111, and the first disassembling clearance, the second disassembling clearance and the third disassembling clearance form the disassembling clearance.

As shown in FIG. 1, when the connection part of the switch box 130 and the battery 150 is located at the lower end face of the switch box 130, the switch box 130 may be removed in the following three directions.

1. The switch box 130 is removed from above.
The switch box 130 is moved upward and is taken out from the first assembling and disassembling port 112.

2. the switch box 130 is removed from the left.
The switch box 130 is firstly moved upward in the accommodating groove 111 until the switch box 130 is separated from the battery 150, and then the switch box 130 is moved to the left and is taken out from a corresponding second assembling and disassembling port 113.

3. The switch box 130 is removed from the right.
The switch box 130 is firstly moved upward in the accommodating groove 111 until the switch box 130 is separated from the battery 150, and then the switch box 130 is moved to the right and is taken out from a corresponding second assembling and disassembling port 113.

As shown in FIG. 2, when the connection part of the switch box 130 and the battery 150 is located at the left end face of the switch box 130, the switch box 130 may be removed in the following two directions.

1. The switch box 130 is removed from above.
The switch box 130 is firstly moved to the right in the accommodating groove 111 until the switch box 130 is separated from the battery 150, and then the switch box 130 is moved upward and is taken out from the first assembling and disassembling port 112.

2. The switch box 130 is removed from the right.
The switch box 130 is moved to the right and is taken out from a corresponding second assembling and disassembling port 113.

As shown in FIG. 3, when the connection part of the switch box 130 and the battery 150 is located at the right end face of the switch box 130, the switch box 130 may be removed in the following two directions.

1. The switch box 130 is removed from above.
The switch box 130 is firstly moved to the left in the accommodating groove 111 until the switch box 130 is separated from the battery 150, and then the switch box 130 is moved upward and is taken out from the first assembling and disassembling port 112.

2. The switch box 130 is removed from the left.
The switch box 130 is moved to the left and is taken out from a corresponding second assembling and disassembling port 113.

In some embodiments, the number of the battery 150 provided in the all-in-one energy storage device 100 is one, and the number of the switch box 130 provided in the all-in-one energy storage device 100 is one. That is, each all-in-one energy storage device 100 is provided with only one battery 150 and one switch box 130, so that the all-in-one energy storage devices 100 can be standardized to have uniform specifications, which reduces manufacturing and usage costs.

In some embodiments, the all-in-one energy storage device 100 is a residential all-in-one energy storage device. That is, the all-in-one energy storage device 100 is in a household environment. On the one hand, the household electricity cost is reduced, and the all-in-one energy storage device 100 can be used as an emergency standby power source to improve the reliability of household power supply. On the other hand, the power grid can be supported in balancing power generation capacity and power demand by configuring the residential all-in-one energy storage device, offering many advantages.

In some embodiments, the all-in-one energy storage device 100 further includes a housing (not shown), and the battery 150, the switch box 130 and the connectors 170 are integrated in the housing. It can be understood that, the battery holder 110 on which the battery 150 and the switch box 130 is mounted is fixed by the housing, which not only provides protection and dust prevention for the battery 150, the switch box 130 and the connectors 170, but also improves the integration of the all-in-one energy storage device 100, avoiding the need for the user to install and wire internally by himself, improving the user experience and facilitating commercialization.

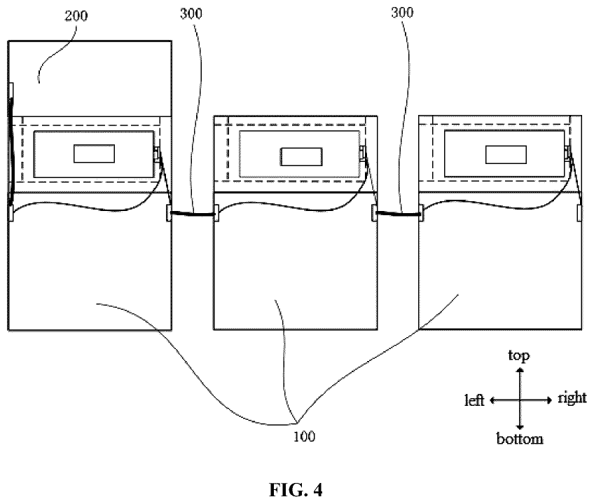

As shown in FIGS. 4 to 9, an energy storage system is also provided according to an embodiment of the present application. The energy storage system includes a power conversion system 200 and at least two all-in-one energy storage devices 100 as described above, where a connector 170 of one of the all-in-one energy storage devices 100 is connected to a connector 170 of another of the all-in-one energy storage devices 100 such that the all-in-one energy storage devices 100 are connected in sequence, and the power conversion system 200 is connected to a connector 170 of one of the all-in-one energy storage devices 100.

The power conversion system 200 (PCS) is configured for controlling the charging and discharging process of the battery 150 and perform alternating-current/direct-current (AC-DC) conversion. The power conversion system 200 is placed on the all-in-one energy storage device 100 and connected to a connector 170 of the all-in-one energy storage device 100 through a wire, which results in convenient and efficient assembly and disassembly, as well as a reduced footprint of the energy storage system.

In the embodiment, the power conversion system 200 is arranged on an upper side of the switch box 130 of the all-in-one energy storage device 100 to reduce the footprint of the energy storage system.

It can be understood that in the embodiment, each of the left and right sides of the battery 150 is provided with the connector 170, such that when the number of the all-in-one energy storage devices 100 is two, capacity expansion is performed by connecting two adjacent connectors 170 respectively located in the two all-in-one energy storage devices 100 through a cable 300; and when the number of the all-in-one energy storage devices 100 is three or more, two connectors 170 respectively located on two sides of the battery 150 are a first connector and a second connector arranged in sequence, the second connector of a first all-in-one energy storage device 100 is connected to the first connector of a second all-in-one energy storage device 100 through a cable 300, and the second connector of the second all-in-one energy storage device 100 is connected to the first connector of a third all-in-one energy storage device 100, and so on, so as to realize the sequential connection of the multiple all-in-one energy storage devices 100.

According to the energy storage system provided in the embodiments of the present application, by providing at least two connectors 170 in the all-in-one energy storage device 100, wiring connections between the all-in-one energy storage device 100 and external devices can be reduced, capacity expansion is convenient, and the installation of the all-in-one energy storage device 100 is simplified. Even when the all-in-one energy storage device 100 needs to be replaced or debugged, the single all-in-one energy storage device 100 can be quickly disassembled by directly unplugging the cables 300 connected to the corresponding connectors 170, which is simple to operate and saves time and labor.

In some embodiments, the energy storage system is provided with multiple all-in-one energy storage devices which are connected in series or in parallel.

It can be understood that in the embodiment, since the multiple all-in-one energy storage devices 100 are provided with one power conversion system 200, the energy storage system adopts a direct-current coupling system which is more efficient and lower in cost than an alternating-current coupling system (where each all-in-one energy storage device 100 is provided with one power conversion system 200).

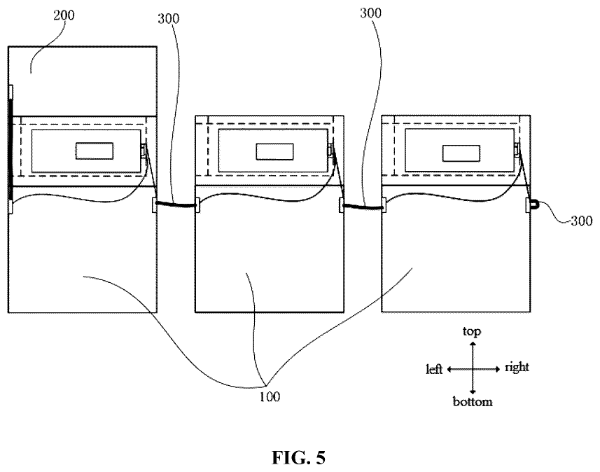

In the embodiment, two adjacent all-in-one energy storage devices 100 are connected in series or in parallel through the electrical connection between the connectors 170. As shown in FIGS. 4, 6 and 8, the multiple all-in-one energy storage devices 100 are connected in parallel. As shown in FIGS. 5, 7 and 9, the multiple all-in-one energy storage devices 100 are connected in series. It should be noted that if the multiple all-in-one energy storage devices 100 needs to be connected in series, a battery 150 of an all-in-one energy storage device 100 located at the end needs to be provided with a cable 300 for short-circuiting.

It can be understood that the number and connection manner of the all-in-one energy storage devices 100 may be determined depending on the actual conditions, which is not specifically limited in the embodiment. In some embodiments, the multiple all-in-one energy storage devices 100 are sequentially arranged along the left-right direction and/or the front-rear direction to adapt to different sizes of spaces for accommodating the energy storage system.

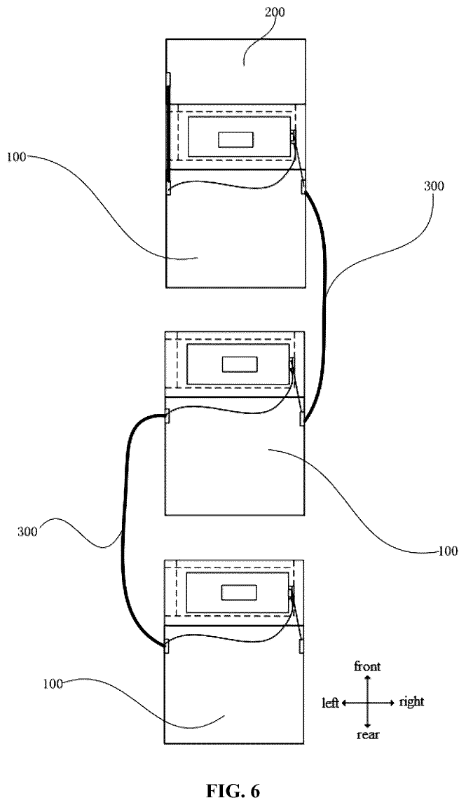

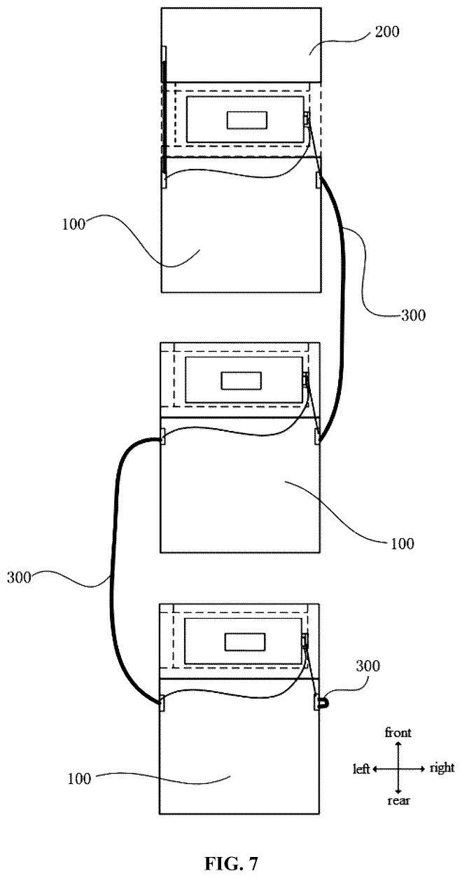

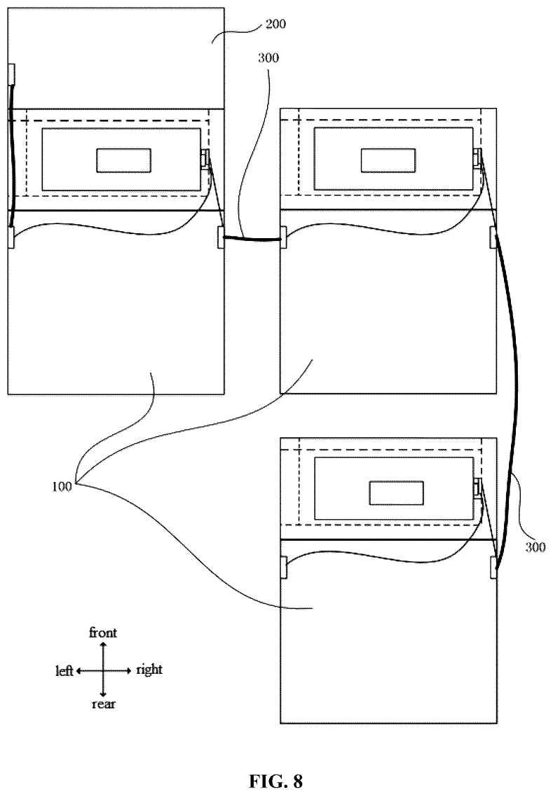

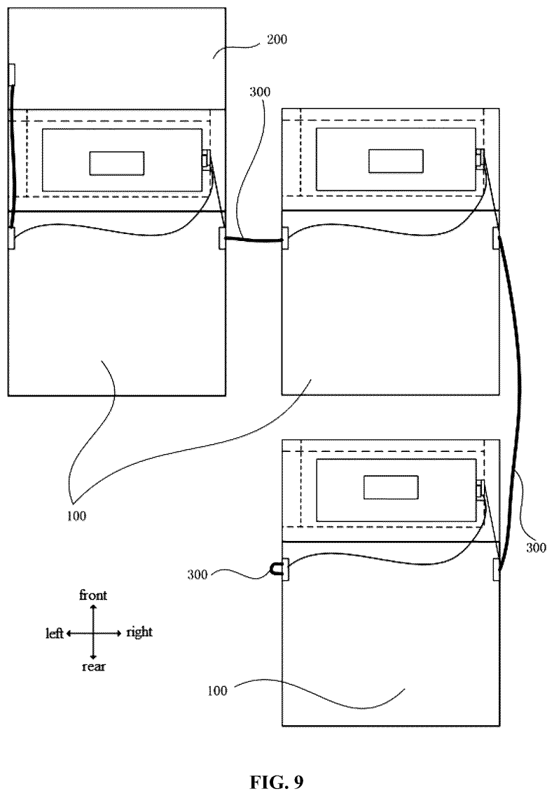

As shown in FIGS. 4 and 5, the multiple all-in-one energy storage devices 100 are sequentially arranged along the left-right direction; as shown in FIGS. 6 and 7, the multiple all-in-one energy storage devices 100 are sequentially arranged along the front-rear direction; and as shown in FIGS. 8 and 9, some of the multiple all-in-one energy storage devices 100 are sequentially arranged along the left-right direction, and some of the multiple all-in-one energy storage devices 100 are sequentially arranged along the front-rear direction.

In this specification and the claims of the present application, the terms “first”, “second”, and so on are intended to distinguish similar objects but not to indicate a specific order or sequence. It should be understood that data used in this way is interchangeable in a suitable case, so that the embodiments of the present application can be implemented in a sequence in addition to the sequences shown or described herein. The objects distinguished by “first”, “second” and so on usually belong to a same class, and the number of the objects is not limited. For example, the number of a first object may be one or more. In addition, “and/or” in the specification and claims means at least one of the objects connected by “and/or”, and symbol “/” generally indicates that a former object and a latter object are associated by an “or” relationship.

In the description of the present application, it should be understood that the orientations or positional relationships indicated by terms “center”, “longitudinal”, “lateral”, “length”, “width”, “thickness”, “up”, “down”, “front”, “rear”, “left”, “right”, “vertical”, “horizontal”, “top”, “bottom”, “inner”, “outer”, “clockwise”, “anticlockwise”, “axial”, “radial” and “circumferential” and the like are based on the orientations or positional relationships shown in the drawings, and are merely for the convenience of describing the present application and the simplification of the description, and do not indicate or imply that a device or element referred to must be in a particular orientation, or be constructed and operated in a particular orientation, and therefore should not be construed as a limitation to the present application.

In the description of the present application, “a first feature” and “a second feature” may include one or more of the features.

In the description of the present application, “multiple” means two or more.

In the description of the present application, a first feature “on” or “under” a second feature may include direct contact between the first feature and second feature, and may also include that the first feature and second feature are not in direct contact but in indirect contact through another feature between them.

In the description of the present application, a first feature “above”, “over” and “on” a second feature includes that the first feature is directly above and obliquely above the second feature, or simply indicates that the first feature is higher in horizontal height than the second feature.

In the description of this specification, descriptions referring to the terms “an embodiment”, “some embodiments”, “exemplary embodiment”, “example”, “specific example” or “some examples” mean that a specific feature, structure, material or characteristic described in connection with the embodiment or example is included in at least one embodiment or example of the present application. In this description, schematic expressions of the above terms do not necessarily refer to the same embodiment or example. Furthermore, the specific feature, structure, material or characteristic described may be combined in any suitable manner in any one or more embodiments or examples.

Although the embodiments of the present application are shown and described, those skilled in the art can understand that various changes, modifications, substitutions and alterations may be made to these embodiments without departing from the principle and spirit of the present application, and the scope of the present application is defined by the claims and their equivalents.

1. An all-in-one energy storage device, comprising:
a battery;
a switch box which is electrically connected to the battery; and
at least two connectors which are connected to the battery and configured for expanding capacity of the all-in-one energy storage device.

2. The all-in-one energy storage device according to claim 1, wherein the switch box is electrically connected to the battery by an aviation connector.

3. The all-in-one energy storage device according to claim 2, wherein the aviation connector of the switch box and the battery is located at a lower end or a side end of the switch box.

4. The all-in-one energy storage device according to claim 2, further comprising:
a battery holder which defines an accommodating groove for accommodating the battery and the switch box;
wherein the battery holder is provided with a plurality of assembling and disassembling ports which are communicated with the accommodating groove; and
wherein a disassembling clearance is defined between an inner wall of the accommodating groove and an outer wall of the switch box when the switch box is arranged in the accommodating groove and is connected to the battery, such that the switch box can be taken out and placed through each of the plurality of assembling and disassembling ports.

5. The all-in-one energy storage device according to claim 1, wherein the number of the battery arranged in the all-in-one energy storage device is one, and the number of the switch box arranged in the all-in-one energy storage device is one.

6. The all-in-one energy storage device according to claim 1, wherein the all-in-one energy storage device is a residential all-in-one energy storage device.

7. The all-in-one energy storage device according to claim 1, further comprising:
a housing in which the battery, the switch box and the at least two connectors are integrated.

8. An energy storage system, comprising:
a power conversion system; and
at least two all-in-one energy storage devices according to claim 1;
wherein a connector of one of the all-in-one energy storage devices is connected to a connector of another one of the all-in-one energy storage devices such that the all-in-one energy storage devices are connected in sequence, and the power conversion system is connected to a connector of one of the all-in-one energy storage devices.

9. The energy storage system according to claim 8, comprising a plurality of all-in-one energy storage devices which are connected in series or in parallel.

10. The energy storage system according to claim 8, wherein the plurality of all-in-one energy storage devices are arranged in sequence along a left-right direction and/or a front-rear direction.

11. The all-in-one energy storage device according to claim 3, further comprising:
a battery holder which defines an accommodating groove for accommodating the battery and the switch box;
wherein the battery holder is provided with a plurality of assembling and disassembling ports which are communicated with the accommodating groove; and
wherein a disassembling clearance is defined between an inner wall of the accommodating groove and an outer wall of the switch box when the switch box is arranged in the accommodating groove and is connected to the battery, such that the switch box can be taken out and placed through each of the plurality of assembling and disassembling ports.

12. The all-in-one energy storage device according to claim 2, wherein the number of the battery arranged in the all-in-one energy storage device is one, and the number of the switch box arranged in the all-in-one energy storage device is one.

13. The all-in-one energy storage device according to claim 3, wherein the number of the battery arranged in the all-in-one energy storage device is one, and the number of the switch box arranged in the all-in-one energy storage device is one.

14. The all-in-one energy storage device according to claim 2, wherein the all-in-one energy storage device is a residential all-in-one energy storage device.

15. The all-in-one energy storage device according to claim 3, wherein the all-in-one energy storage device is a residential all-in-one energy storage device.

16. The all-in-one energy storage device according to claim 2, further comprising:
a housing in which the battery, the switch box and the at least two connectors are integrated.

17. The all-in-one energy storage device according to claim 3, further comprising:
a housing in which the battery, the switch box and the at least two connectors are integrated.
